(19) United States
(12) Patent Application Publication
(10) Pub. No.: US 2006/0197885 A1
(43) Pub. Date: Sep. 7, 2006

(54) Liquid crystal display having a repair line with reduced parasitic capacitance and method for manufacturing the same

(76) Inventors: Kuei-Sheng Tseng, Bade City (TW); Chu-Yu Liu, Dongshih Township (TW); Chung-Jen Cheng Chiang, Ji-an Township (TW)

Correspondence Address: RABIN & Berdo, PC, 1101 14TH STREET, NW, SUITE 500, WASHINGTON, DC, 20005, US

(21) Appl. No.: 11/206,790

(22) Filed: Aug. 19, 2005

(30) Foreign Application Priority Data
Mar. 2, 2005 (TW) 94106352

(51) Int. Cl. G02F 1/1333

(52) U.S. Cl. 349/54

(57) ABSTRACT

A liquid crystal display having a repair line with reduced parasitic capacitance and a method for manufacturing the same. The liquid crystal display includes a first substrate, a second substrate, a plurality of crystal liquid molecules, a repair line, and a protrusion. The first substrate includes a color filter. The second substrate, disposed substantially parallel to the first substrate, includes an active matrix having a plurality of scan lines and signal lines interlaced each other. The crystal liquid molecules are disposed between the first and second substrates. The repair line is disposed on an outer side of the active matrix. The protrusion is opposite to the repair line and disposed on a side of the first substrate that is opposite to the second substrate.

This application claims the benefit of Taiwan application Serial No. 94106352, filed Mar. 2, 2005, the subject matter of which is incorporated herein by reference.

### BACKGROUND OF THE INVENTION

1. Field of the Invention

The invention relates in general to a liquid crystal display (LCD) and a method for manufacturing thereof, and more particularly to an LCD having a repair line with reduced parasitic capacitance.

2. Description of the Related Art

FIG. 1A illustrates a conventional structure of an LCD. The conventional LCD 10 includes a data driver 120, signal lines 125, and conventional LCD panel 100. The data driver 120 drives the conventional LCD panel 100 through the signal lines 125 so as to display video frames. One of the signal lines 125 is electrically connected to a plurality of pixel electrodes. When one of the signal lines 125 is broken, as shown at location D, display deficiency occurs because some of the related pixel electrodes fail to electrically connect to the data driver 120 and cannot receive data signals. A conventional approach to repairing the broken one of the signal lines 125 is to dispose a repair line 110 on the borders of the conventional LCD panel 100. When one of the signal lines 125 is broken, two opening ends of the broken signal line, for example A and B as shown in FIG. 1A, can be made connected to the repair line 110 by using laser welding. In this way, video data from the data driver 120 can be fed into the pixel electrodes that previously failed to be connected to the data driver 120 due to the broken one of the signal lines 125.

The influence of the repair line 110 on the conventional LCD panel 100 can be analyzed in terms of the physical structure of the conventional LCD panel 100. FIG. 1B is cross-sectional view of the LCD taken along line 1B-B′, where a first substrate 115, a second substrate 116, and a repair line 110 of the conventional LCD panel 100 are illustrated. The second substrate 116 includes an active matrix (not shown in FIG. 1B) formed by interlacing the signal lines and scan lines, and the repair line 110 is disposed on an outer side of the active matrix. Liquid crystal molecules 180 are sandwiched between the first substrate 115 and second substrate 116, and the second substrate 116 is disposed substantially parallel to the first substrate 115. The first substrate 115 includes a first glass substrate 130, color filter 150, and common electrodes 155. The second substrate 116 includes pixel electrodes (not shown in FIG. 1B), a second glass substrate 140, a silicone nitride (Si₃N₄) layer 145, and a passivation layer 190. Since parasitic capacitance is formed between the repair line 110 and the common electrodes 155 which are opposite to the repair line 110, signal distortion and delay may occur on the repair line 110.

FIG. 1C illustrates an equivalent circuit formed between common electrodes and a repair line. As observed from the cross-sectional view of the conventional LCD panel, the liquid crystal molecules 180 sandwiched between the first substrate 115 and second substrate 116 can be regarded as liquid crystal equivalent capacitance Clc, and the passivation layer 190 as passivation layer equivalent capacitance Cpv. In terms of the two equivalent capacitances, the parasitic capacitance between the common electrodes 155 and repair line 110 can be viewed as a capacitance formed by the serial connection of the liquid crystal equivalent capacitance Clc to the passivation layer equivalent capacitance Cpv.

Additionally, the formula of capacitance is C=ε₀×ε×A÷d, where ε₀ stands for the dielectric constant of vacuum, ε stands for the dielectric constant of the material, A represents the capacitor area, and d is referred to as the thickness of the material. For the same capacitor area A and dielectric constant of vacuum ε₀, the passivation layer equivalent capacitance Cpv depends on the dielectric constant of the passivation layer ε₁ and the height of the passivation layer between the common electrodes 155 and repair line 110, that is, Cpv=ε₀×ε₁×A÷d1. Likewise, liquid crystal equivalent capacitance Clc depends on the dielectric constant of the liquid crystal molecules and the height of the liquid crystal molecule layer between the common electrodes 155 and repair line 110, d2, that is, Clc=ε₀×ε₂×A÷d2. For example, if ε₁=6.6, ε₂=7.5, d1=0.2 μm, d2=4 μm, the parasitic capacitance between the common electrodes 155 and repair line 110 in the conventional LCD panel 100 is about 1.77ε₀A according to the above formula of capacitance.

FIG. 1D illustrates the transmission of the electrical signals on the repair line. Since the parasitic capacitance, as seen from the equivalent circuit diagram, exists between the common electrodes 155 and repair line 110, signal distortion occurs on the repair line 110 through which video data on the one of signal lines 125 is transmitted from A to B, for example. As illustrated in FIG. 1D, at one end of the repair line 110, such as location A of the repair line 110, a square waveform, indicated by S, of a video data signal is transmitted initially in a fine shape. However, at the terminating end of the repair line 110, such as location B of the repair line 110, the square waveform is seriously distorted, as indicated by S′, since the resistance and capacitance (RC) loading is formed on the repair line 110 by the resistance and the parasitic capacitance of the repair line 110.

Thus, it is desirable for LCD manufacturers to effectively reduce signal distortion occurred on the terminating end of the repair line due to RC loading when the repair line is employed to repair broken signal lines of an LCD.

### SUMMARY OF THE INVENTION

It is therefore an object of the invention to provide a liquid crystal display apparatus having a repair line with reduced parasitic capacitance and a method for manufacturing the same.

According to the object of the invention, a liquid crystal display apparatus having a repair line with reduced parasitic capacitance is provided. The liquid crystal display apparatus includes a first substrate, a second substrate, a plurality of crystal liquid molecules, a repair line, and a protrusion. The first substrate includes a color filter. The second substrate, disposed substantially parallel to the first substrate, includes an active matrix having a plurality of scan lines and signal lines interlaced each other. The crystal liquid molecules are disposed between the first and second substrates. The repair line is disposed on an outer side of the active matrix. The protrusion is opposite to the repair line and disposed on a side of the first substrate that is opposite to the second substrate.

According to another object of the invention, a method for manufacturing a liquid crystal display apparatus having a repair line with reduced parasitic capacitance is provided. First, a first substrate and a second substrate are provided. Next, an active matrix having a plurality of scan lines and signal lines interlaced each other is formed on the second substrate. A repair line is disposed on an outer side of the active matrix. After that, a protrusion is disposed on a side of the first substrate that is opposite to the second substrate so that the protrusion is opposite to the repair line. Finally, a plurality of crystal liquid molecules are disposed between the first and second substrates.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Related Art) illustrates a conventional structure of an LCD.

FIG. 1B (Related Art) is cross-sectional view of the LCD taken along line 1B-1B′.

FIG. 1C (Related Art) illustrates an equivalent circuit formed between common electrodes and repair lines.

FIG. 1D (Related Art) illustrates the transmission of the electrical signals on the repair lines.

FIG. 2A shows a top view of an LCD having repair lines with reduced parasitic capacitance according to an embodiment of the invention.

FIG. 2B show a cross-sectional view of an LCD having repair lines with reduced parasitic capacitance, taken along line 2B-2B′ in FIG. 2A.

FIG. 3 illustrates an equivalent circuit formed between common electrodes and repair lines according to the embodiment of the invention.

FIG. 4 shows a manufacturing process of an LCD having repair lines with reduced parasitic capacitance according to an embodiment of the invention.

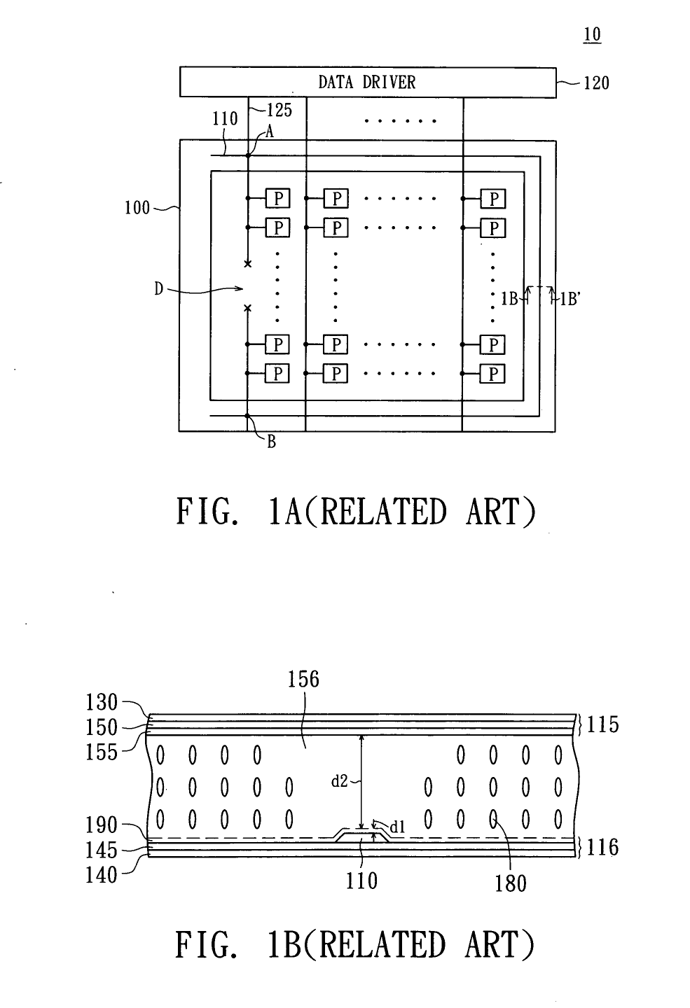

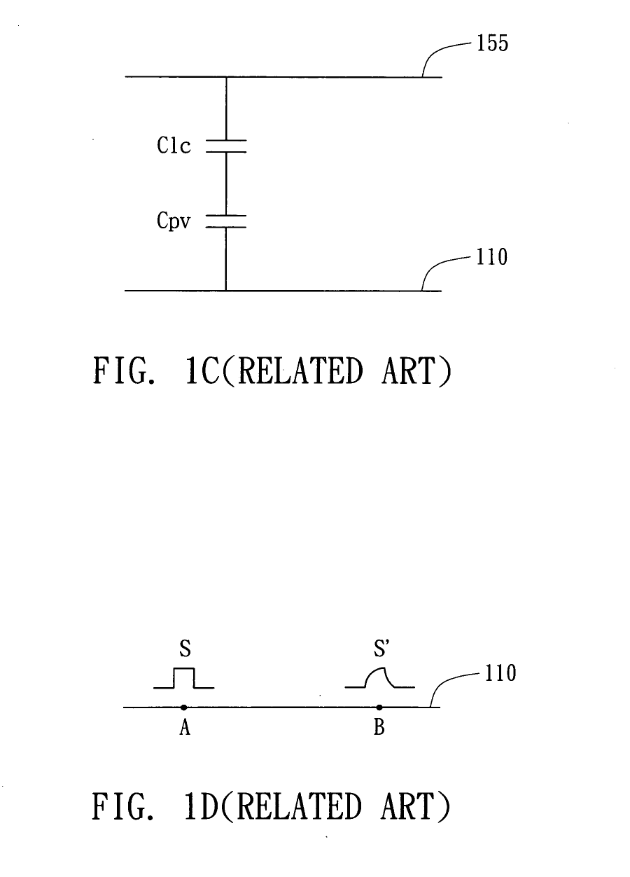

### DETAILED DESCRIPTION OF THE INVENTION

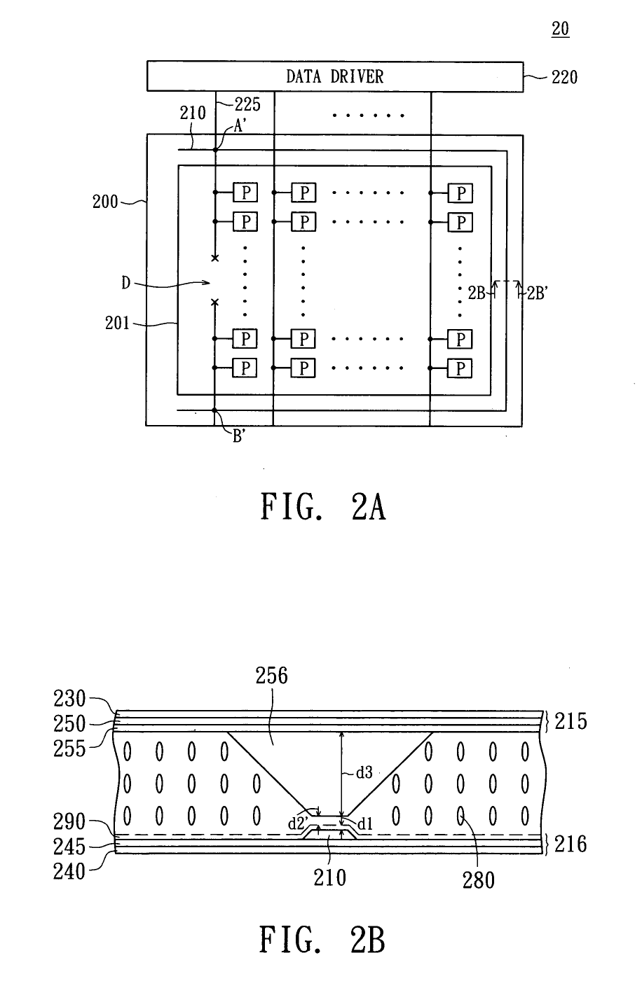

An LCD having a repair line with reduced parasitic capacitance 20 is shown in FIGS. 2A and 2B according to an embodiment of the invention, where FIG. 2A shows a top view of the LCD and FIG. 2B shows a cross-sectional view of the LCD taken along line 2B-2B′ in FIG. 2A. An LCD panel 200 includes a first substrate 215, a second substrate 216, liquid crystal molecules 280, a repair line 210 and a protrusion 256. The first substrate 215 includes a color filter 250. The second substrate 216 includes an active matrix 201 formed with scan lines (not shown in the drawings) and signal lines 225 interlaced each other. The repair line 210 is disposed on an outer side of the active matrix 201. The second substrate 216 is disposed substantially parallel to the first substrate 215. The liquid crystal molecules 280 are disposed between the first substrate 215 and second substrate 216. The protrusion 256 is opposite to the repair line 210 and disposed on a side of the first substrate 215 that is opposite to the second substrate 216. The protrusion 256 is made of a low dielectric constant material, whose dielectric constant is required to be lower than the dielectric constant of the liquid crystal molecules 280, for example, acrylic or photo-resistor.

In addition, the first substrate 215 includes a first glass substrate 230, the color filter 250 and common electrodes 255. The second substrate 216 includes a second glass substrate 240, the signal lines 225, a silicone nitride (Si₃N₄) layer 245, the repair line 210, and a passivation layer 290. When one of the signal lines 225 has broken, such as the one shown in FIG. 2A, the broken signal line can be repaired by connecting two opening ends of the broken signal line to the repair line 210 through laser welding.

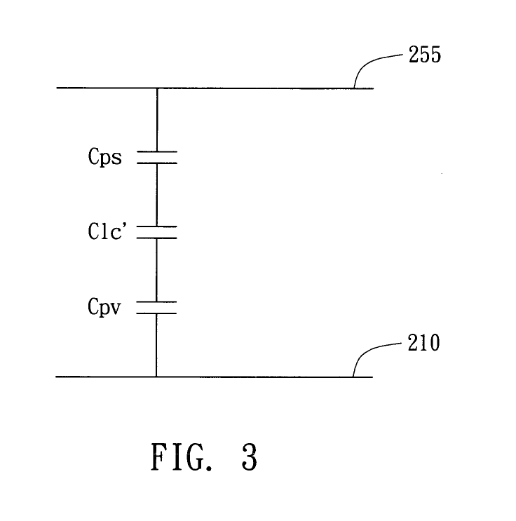

FIG. 3 illustrates an equivalent circuit formed between common electrodes and repair lines according to the embodiment of the invention. While the repair line 210 is employed to repair a broken one of the signal lines 225 in order for a signal to be transmitted from point A′ to point B′, a parasitic capacitance, including three equivalent capacitance, is formed between the repair line 210 and the common electrodes 255 because the repair line 210 is opposite to the common electrodes 255. The first equivalent capacitance is formed by the liquid crystal molecules 280 between the first substrate 215 and second substrate 216, referred to as a liquid crystal equivalent capacitance Clc′. The second equivalent capacitance is formed by the passivation layer 290, referred to as a passivation layer equivalent capacitance Cpv. The third one, formed by the protrusion 256, is called a low dielectric constant material equivalent capacitance Cps. Thus, the equivalent parasitic capacitance between the common electrodes 255 and repair line 210 can be defined in terms of the three equivalent capacitances in series, that is, the liquid crystal equivalent capacitance Clc′, passivation layer equivalent capacitance Cpv, and low dielectric constant material equivalent capacitance Cps, connected in series.

Further, the capacitance of a capacitor is defined by C=ε₀×ε×A÷d, where ε₀ and ε stand for the dielectric constant of vacuum and the material, respectively, A represents the capacitor area, and d is referred to as the thickness or height of the material. For the same capacitor area A and ε₀, the passivation layer equivalent capacitance Cpv depends on the dielectric constant of the passivation layer ε₁ and the height of the passivation layer between the common electrodes 255 and repair line 210, d1, that is, Cpv=ε₀×ε₁×A÷d1. The liquid crystal equivalent capacitance Clc′ depends on the dielectric constant of the liquid crystal molecules, denoted by ε₂, and the height of the liquid crystal molecule layer between the common electrodes 255 and repair line 210, d2′, that is, Clc′=ε₀×ε₂×A÷d2′. The capacitance of the Cps depends on the dielectric constant of the low dielectric constant material, ε₃, and the height of the low dielectric constant material between the common electrodes 255 and repair line 210, d3, that is, Cps=ε₀×ε₃×A÷d3. For example, if ε₁=6.6, ε₂=7.5, ε₃=4, d1=0.2 μm, d2′=0.4 μm, and d3=3.6 μm, the parasitic capacitance is about 1.02ε₀A according to the above formula of capacitance.

As compared with the conventional LCD panel 100, the LCD panel 200 with the disposition of the protrusion 256 on an inner side of the first substrate 215 opposite to the repair line 210 reduces the parasitic capacitance from 1.77ε₀A to 1.02ε₀A, under the above conditions. That is, the parasitic capacitance has been reduced by about 42%.

Since reduced parasitic capacitance is achieved, when the repair line 210 is used to repair a broken one of the signal lines 225 in order for a signal to transmit from point A′ to point B′ in the embodiment according to the invention, the signal waveform would be less distorted by RC loading.

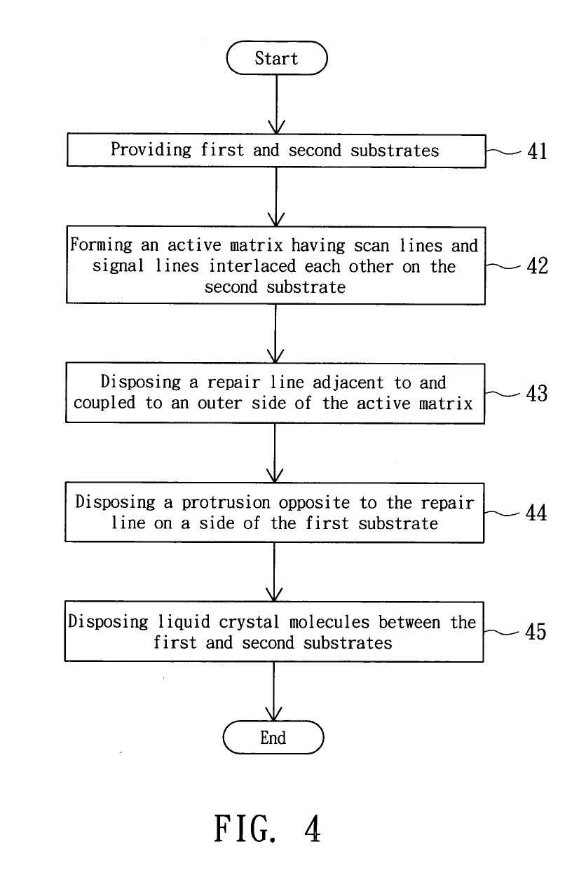

Referring to FIG. 4, a manufacturing process of an LCD having a repair line with reduced parasitic capacitance is shown according to one embodiment of the invention. The manufacturing process includes the following steps. First, in step 41, a first substrate 215 and a second substrate 216 are provided. Next, an active matrix having scan lines and signal lines 225 interlaced each other is formed on the second substrate 216, as indicated by step 42. A repair line 210 is then disposed adjacent to and coupled to an outer side of the active matrix, as in step 43. After that, in step 44, a protrusion 256 is disposed opposite to the repair line 210 and on a side of the first substrate 215 opposite to the second substrate 216. Finally, liquid crystal molecules 280 are disposed between the first substrate 215 and second substrate 216. Further, for the sake of manufacturing simplicity, the repair line 210 can be formed on the second substrate 216 while the active matrix is being formed. The steps above, such as steps 42 and 43, can be performed in any possible sequence in order to form an active matrix with a repair line with reduced parasitic capacitance according to the invention.

The embodiments above have disclosed a liquid crystal display having a repair line with reduced parasitic capacitance and a method for manufacturing the same. The parasitic capacitance between the repair line and common electrodes has been greatly reduced through the disposition of a low dielectric constant material on an inner side of the first substrate. In this way, RC loading due to the parasitic capacitance in the embodiments becomes not so significant as the conventional one and the signal on the terminating end of the repair line would be less distorted by the RC loading.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, comprising:
a first substrate, comprising a color filter;
a second substrate, disposed substantially parallel to the first substrate, the second substrate comprising an active matrix having a plurality of scan lines and signal lines interlaced each other;
a plurality of crystal liquid molecules, disposed between the first and second substrates;
a repair line, disposed on an outer side of the active matrix; and
a protrusion, opposite to the repair line and disposed on a side of the first substrate that is opposite to the second substrate.

2. The display apparatus according to claim 1, wherein the repair line serves for electrically connecting to a signal line that is broken.

3. The display apparatus according to claim 1, wherein the protrusion is made of a low dielectric constant material.

4. The display apparatus according to claim 3, wherein the protrusion has a dielectric constant which is lower than the dielectric constant of the crystal liquid molecules.

5. The display apparatus according to claim 1, wherein the protrusion comprises acrylic.

6. The display apparatus according to claim 1, wherein the protrusion comprises photo-resistor.

7. A method for manufacturing a display apparatus, comprising the steps of:
providing a first substrate and a second substrate;
forming an active matrix having a plurality of scan lines and signal lines interlaced each other on the second substrate and disposing a repair line on an outer side of the active matrix;
disposing a protrusion on a side of the first substrate that is opposite to the second substrate so that the protrusion is opposite to the repair line; and
disposing a plurality of crystal liquid molecules between the first and second substrates.

8. The method according to claim 7, wherein the repair line serves for electrically connecting to a signal line that is broken.

9. The method according to claim 7, wherein the protrusion comprises a low dielectric constant material.

10. The method according to claim 9, wherein the protrusion has a dielectric constant which is lower than the dielectric constant of the crystal liquid molecules.

11. The method according to claim 10, wherein the protrusion comprises acrylic.

12. The method according to claim 10, wherein the protrusion comprises photo-resistor.
